(19) United States
(12) Patent Application Publication
(10) Pub. No.: US 2007/0016648 A1
(43) Pub. Date: Jan. 18, 2007

(54) Enterprise Message Mangement

(76) Inventor: Ronald C. Higgins, Woodinville, WA (US)

Correspondence Address: WHITAKER LAW GROUP, 755 WINSLOW WAY EAST, SUITE 304, BAINBRIDGE ISLAND, WA, 98110, US

(21) Appl. No.: 11/457,130

(22) Filed: Jul. 12, 2006

Related U.S. Application Data
(60) Provisional application No. 60/698,840, filed on Jul. 12, 2005.

(51) Int. Cl. G06F 15/16

(52) U.S. Cl. 709/206

(57) ABSTRACT

A message archival system interacts with an enterprise messaging system to receive notice of messages. Messages being transmitted to users of the enterprise messaging system are made available to the message archival system. The message archival system indexes content within each message, and stores the messages. The indexed information can be searched for quick, elaborate searches of a large number of messages.

### CROSS REFERENCE TO RELATED APPLICATIONS

This application claims priority to co-pending U.S. Provisional Application No. 60/698,840, entitled Electronic Message Management System, filed on Jul. 12, 2005, which is hereby incorporated by reference for all purposes.

### BACKGROUND

Today e-mail and other new forms of communication, such as Instant Messaging (IM) and Voice-Over-Internet Protocol (VOIP), are a continually growing and dominant means of communication. By some estimates, there are over 52 billion e-mail messages and 2 billion IMs sent each day. Moreover, as much as 70% of a company's electronic documents may be contained in e-mail, presenting significant challenges to organizations. The sheer volume of messages and the critical business data contained in the communications present serious business issues.

For example, human resource departments cannot enforce adherence to e-mail, IM, and VOIP policies that are designed to protect their companies from costly litigation. Companies cannot easily police and restrict intellectual property from leaving their organization and ending up in the hands of competitors. Complying with regulatory requirements such as SEC, Sarbanes-Oxley, NASD, and other compliance directives is costly and time consuming. Companies are liable for messages generated on their systems, and the courts view this information as formal legal documentation. Employees and managers cannot easily search or retrieve valuable intra-company communication impacting employee productivity (knowledge management). The inability to produce messaging content in a timely manner can expose organizations to potential fines, litigation, court actions, and sanctions.

For these and other reasons, an adequate message archival and retrieval system has eluded those skilled in the art of knowledge discovery, until now.

### SUMMARY

The invention is directed at mechanisms and techniques for managing messages. Generally stated, embodiments are directed at a system for archiving and indexing messages in such a manner that they are easily located and retrieved.

### BRIEF DESCRIPTION OF THE DRAWINGS

FIG. 1 is a functional block diagram generally illustrating a system for archiving messages in accordance with one embodiment of the invention.

FIG. 2 is a functional block diagram illustrating in greater detail components of the message archive server introduced in conjunction with FIG. 1.

FIG. 3 is a functional block diagram illustrating in greater detail the index store introduced in conjunction with FIG. 2.

FIG. 4 is a functional block diagram illustrating in greater detail the message archive introduced in conjunction with FIG. 2.

FIG. 5 is a conceptual illustration of a sample message of the type that may be archived and retrieved.

FIG. 6 is a functional block diagram generally illustrating a client computer, which may be any computing device coupled to the message archive server.

FIG. 7 is an operational flow diagram generally illustrating steps performed by a process for indexing words in messages, in accordance with one embodiment.

FIG. 8 is an operational flow diagram generally illustrating steps performed by a process for searching for messages in a message archive, in accordance with one embodiment.

### DETAILED DESCRIPTION OF THE DRAWINGS

In the following detailed description, reference is made to the accompanying drawings in which is shown, by way of illustration only, various embodiments for practicing the invention. It will be understood that many other embodiments may be used, and structural and functional modifications may be made without departing from the spirit and scope of the invention.

Briefly stated, embodiments are directed at a message archival system. The message archival system interacts with an enterprise messaging system to receive notice of messages. Messages being transmitted to users of the enterprise messaging system are made available to the message archival system. The message archival system indexes content within each message, and stores the messages. The indexed information can be searched for quick, elaborate searches of a large number of messages. Particular, non-exclusive embodiments of these general concepts will now be described.

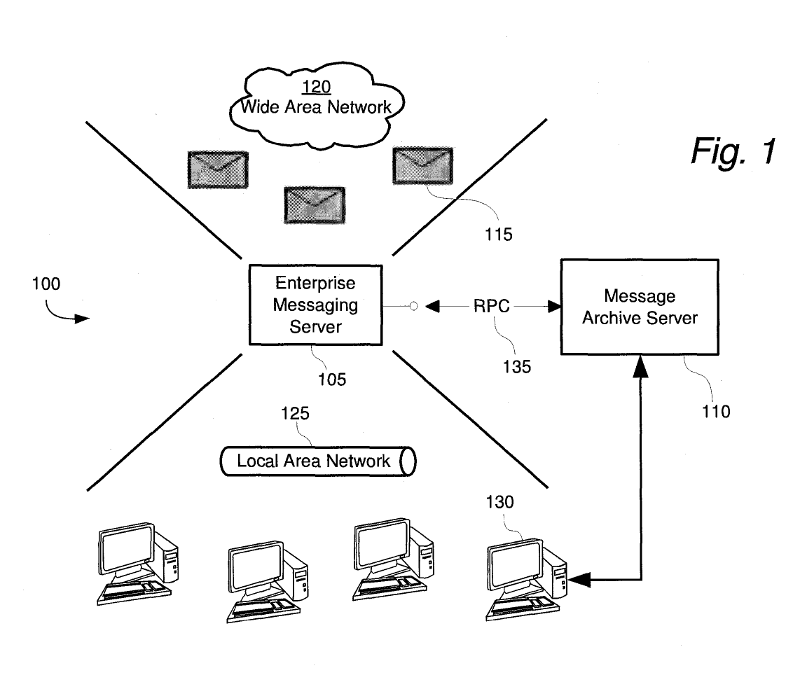

FIG. 1 is a functional block diagram generally illustrating a system 100 for archiving messages in accordance with one embodiment of the invention. In this embodiment, the system 100 includes an enterprise messaging server 105 and a message archive server 110. The enterprise messaging server 105 of this embodiment is an e-mail server, such as the “Exchange Server” messaging system in common use today. The Exchange Server messaging system is owned and licensed by the Microsoft Corporation. Typically, the messaging server 105 receives messages, such as e-mail messages 115, both over a wide area network 120 and over a local area network 125. In alternative embodiments, the messaging server 105 could be a system for facilitating instant messages between users, either in addition to or in lieu of e-mail messages.

Commonly, “outside” individuals send messages inbound from the wide area network 120 to users (such as client computer 130) of the enterprise messaging server 105. Users on the local area network 125 can send each other messages completely “inside” the enterprise, or outside the enterprise to individuals over the wide area network 120. This embodiment is capable of archiving messages that travel outside-to-inside, inside-to-outside, as well as even messages that are completely inside the enterprise.

The message archive server 110 of this embodiment is a system that captures, indexes and archives electronic messages. Generally stated, the message archive server 110 provides a back-end capture mechanism for archiving and indexing messages, and a front-end tool for searching, viewing and recovering that message history. One particular, non-exclusive example of such a message archive server 110 is the LookingGlass records management product owned and licensed by Estorian, Inc. of Kirkland, Wash.

In this implementation, the message archive server 110 implements Remote Procedure Calls (RPCs) 135 to interface with the enterprise messaging server 105. As is known in the art, an RPC is a protocol that allows a computer program running on one computer to cause a subroutine on another computer to be executed. Accordingly, the message archive server 110 is configured to interface with routines (e.g., APIs) exposed by the enterprise messaging server 105 that make certain functionality accessible. In this way, the message archive server 110 can be implemented without injecting new code or modifying existing code of the enterprise messaging server 105.

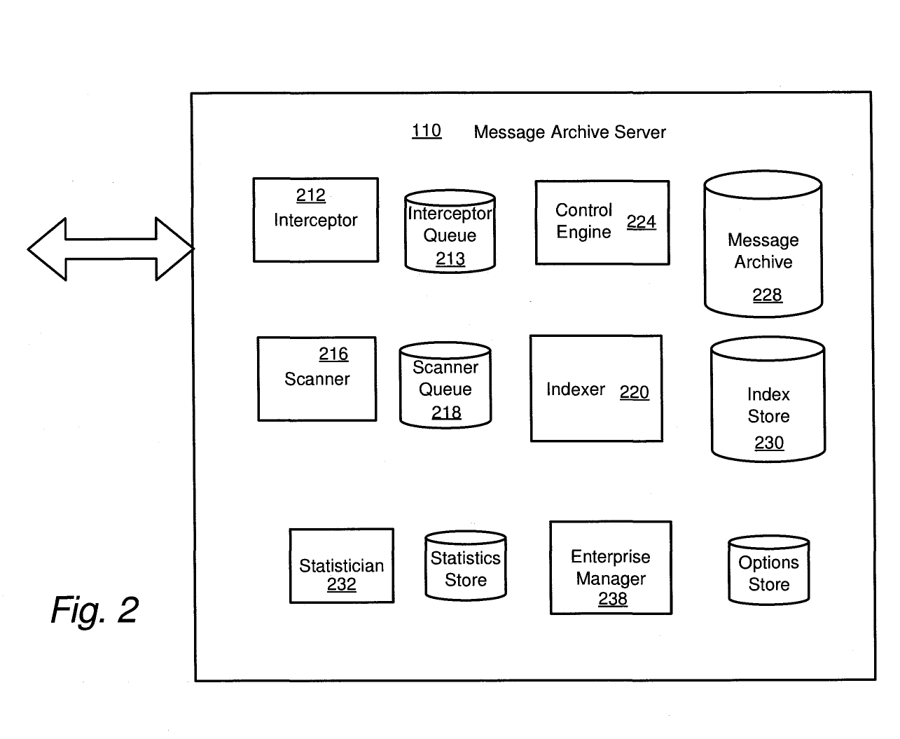

The message archive server 110 introduced above may be implemented in many different ways and with many different components. However, one particular implementation will now be described, with reference to FIGS. 2 through 6, by way of illustration only. The particular components described here and illustrated in the Figures can be implemented in many other ways too numerous to list here. However, the omission of those other embodiments is for the purpose of simplifying the discussion only, and not for the purpose of excluding any alternatives from the scope of this patent.

FIG. 2 is a functional block diagram illustrating in greater detail components of the message archive server 110 introduced above in conjunction with FIG. 1. In this particular implementation, the message archive server 110 includes an interceptor 212, a scanner 216, an indexer 220, and a control engine 224. Each of these components are described here as functional components, and it will be appreciated that their functionality may actually be distributed over several different actual software components, implemented in fewer software components than the functional components described here, or some combination. The components described here are illustrative only.

The control engine 224 typically is installed and executes on a dedicated computer system designated as the formal message archive server 110. When the control engine 224 starts, it launches the interceptor 212 and an appropriate number of instances of the scanner 216 and the indexer 220, as described below. The control engine 224 also monitors each of the executing components, and may display their status and progress on screen as they perform their tasks.

The interceptor 212 is a multi-threaded software component that uses remote procedure calls (RPCs) to retrieve messages from one or more messaging servers. In accordance with this embodiment, the interceptor 212 may register with the messaging server(s) for notice of a “message event,” such as the arrival of a new message, or the deletion of an existing message. To avoid overloading during periods of high message volume, the interceptor 212 may simply capture each message from the messaging server as it arrives and writes the message to a queue on disk (the interceptor queue 213).

The scanner 216 is a software component that interacts with the messaging server to scan for existing messages. Most enterprise messaging systems may already have a large numbers of messages when the message archive server 110 is first put into service. These historical messages can also be extracted, indexed and archived. The scanner 216 serves this purpose by scanning mailboxes (or other message repositories) for existing messages, determining if the existing messages have been processed yet, and queuing them for indexing if they have not.

The scanner 216—or more specifically, instances of the scanner—performs background tasks, and may run when message activity is low to conserve resources. A time schedule for the scan processes may be user configurable, such as through an options form of the control engine 224. During those time periods, the control engine 224 assigns mailboxes to one or more instances of the scanner 216. More than one instance of the scanner 216 is usually running, and each instance is assigned a list of mailboxes on the messaging server to scan. The scanner 216 opens a mailbox and matches the messages in it with the messages in the index store 230. If the scanner 216 finds a message in the mailbox that is not in the index store 230, it writes the message to the scanner queue 218.

During its scan of each mailbox, the scanner 216 also determines if messages have been moved to another folder or deleted. If so, the scanner 216 notes this information as a “DateRemoved” value associated with the message. The scanner 216 may also capture statistics about the mailbox, including the number of messages it currently contains, their sizes, their attachments, the number of messages sent and received today, and so forth. This statistical information can also be saved, such as in the index store 230, for later review.

This scanning function may be performed on a schedule (e.g, nightly, weekly, first Sunday of each month, etc.) or manually. The manual scan process may be performed when the message archive server 110 is first activated, for example.

As mentioned, the control engine 224 monitors each of the other components of the system. Accordingly, when the control engine 224 detects messages in either the interceptor queue 213 or the scanner queue 218, it assigns each queued message to a running instance of the indexer 220.

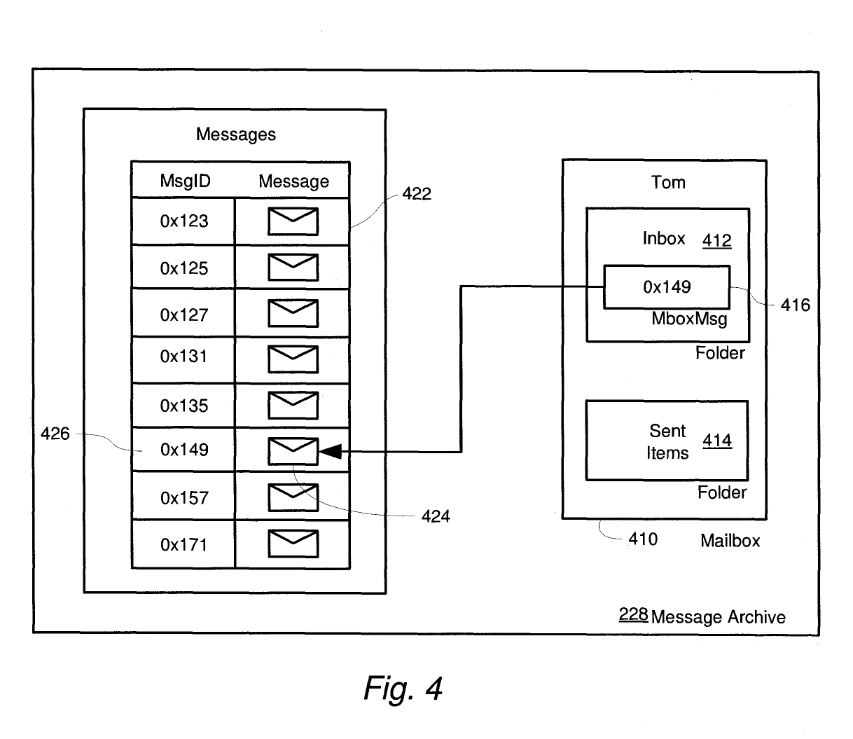

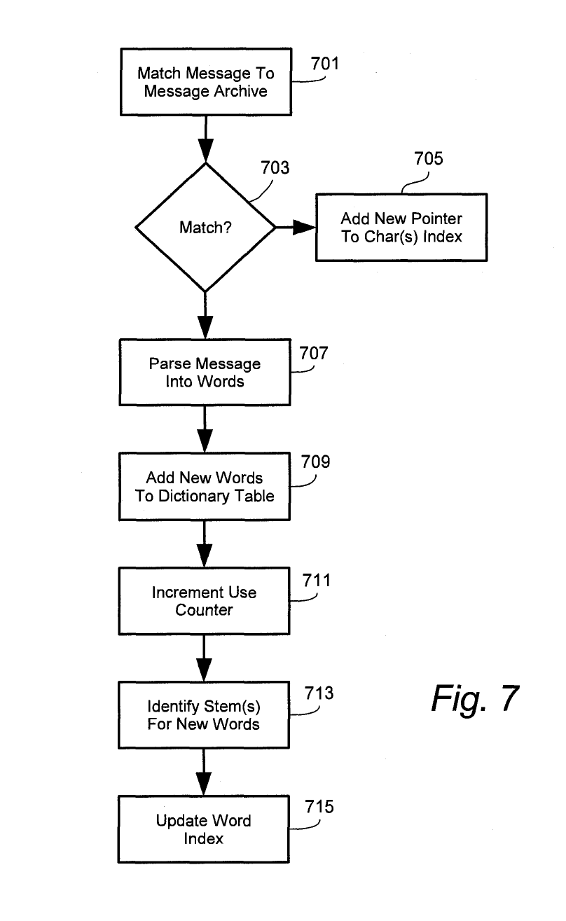

The indexer 220 is a software component that indexes unstructured data, and stores and retrieves the data into virtual folders for review and/or reproduction. Virtual folders are created dynamically as a repository for search results. Virtual folders can be named anything by the user and take any form. As the indexer 220 is handed messages by the control engine 224, it performs a number of tasks on each message. A detailed description of operations that may be performed by one implementation of the indexer 220 is described below in conjunction with FIG. 7. However, briefly stated, the indexer 220 parses each message to identify alphanumeric strings within the message, it sorts each of the identified character strings, it stores the message in the message archive 228 (described in greater detail in conjunction with FIG. 4), and it indexes each character string in the index store 230 (described in greater detail in conjunction with FIG. 4) with a pointer to the corresponding message in the message archive 228.

Several instances of the Indexer are typically running concurrently, each processing its own list of messages assigned by the control engine 224. The progress of each indexer 220 may displayed on screen as messages are parsed into lists of words and added to the index store.

Several additional components could also be included, such as a statistician 232 and an enterprise manager 238. In one implementation, statistics are collected as part of a periodic scanning process by the scanner 216. However, some customers may prefer that statistics be updated on a different schedule, such as regularly throughout the day, while other customers may want to disable statistics altogether. To that end, the statistician 232 may be executed separately, under control of the control engine 224, or as multiple processes.

The enterprise manager 238 may be implemented with a number of tools for maintaining and configuring the index store 230 and message archive 228. Configuration options for configuring the message archive server 110 may be controlled by the enterprise manager 238. The enterprise manager 238 could be executed directly on the message archive server 110, or it could be executed on a separate workstation. Executing the enterprise manager 238 on a separate workstation could allow administration of the message archive server 110 without compromising the physical security of its host server or without having to be physically proximate to the server.

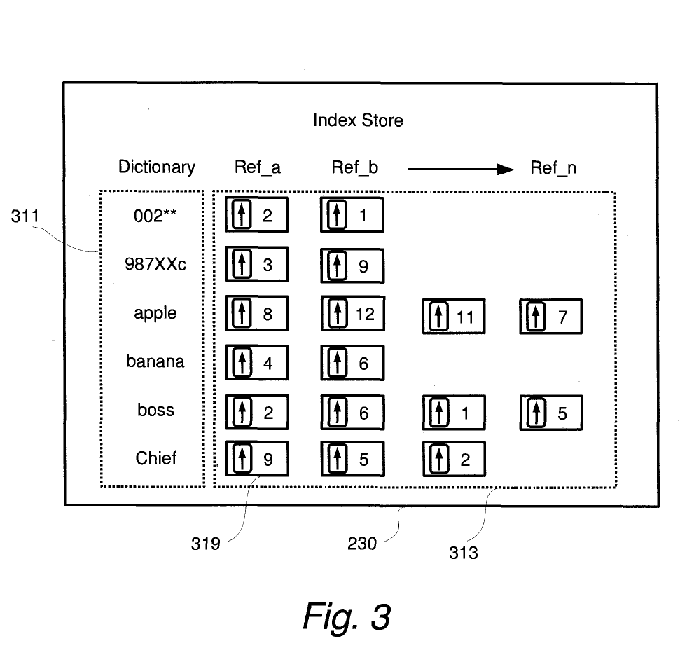

FIG. 3 is a functional block diagram illustrating in greater detail the index store 230 introduced above. In this particular embodiment, the index store 230 may be implemented as a series of tables in a database with each table representing information about data discovered in the archived messages. A “dictionary table” 311 includes records that each represent a unique character string found in one or more messages or attachments. It should be noted that throughout this document, any use of the term “word” or “character string” includes any string of alphabetic and/or numeric characters. Punctuation characters, special characters, and spaces may be omitted.

A word index 313 includes records that each represent a count of how many times a particular word appears in a particular message, with a pointer to the corresponding message. Each record is associated with a particular word in the dictionary table 311. For example, index record 319 represents the occurrence of the word “Chief” in a particular message nine times. Other messages that include the word “Chief” have corresponding records in the word index 313 also associated with the dictionary entry for “Chief.”

The index record 319 also includes pointers to the particular messages in which the word was found. In one particular embodiment, the pointer may include a message identifier for the actual message stored in the message archive 228 (FIG. 2). In this way, the word index 313 relates every word or character string to one or more messages in the message archive 228, thereby reducing a search for any message containing a search word to a simple table look-up.

In certain implementations, the Porter Stemmer algorithm may be used to identify similar words (for example: ‘developer’, ‘development’, ‘developing’, ‘developed’, etc.). Since the programming for stemming algorithms is generally processor-intensive, each unique stem may be stored in a stems table (not shown), and may include a pointer from the dictionary table 311 to the stems table, associating each word with its stem word. In addition, a synonyms table (not shown) may be used for synonyms of words in either the dictionary table 311 or the stems table. For example, if a search is performed on the word “porn”, synonyms such as “porno”, “pornography”, “smut”, etc. can optionally be searched. To that end, the synonyms table may contain a list of synonyms associated with a given word.

FIG. 4 is a functional block diagram illustrating in greater detail the message archive 228 introduced above. In one embodiment, the message archive 228 may be implemented as a series of tables with information to facilitate the retrieval of messages.

In this implementation, the message archive 228 includes a message table 422 that includes records for each unique message discovered by the indexer 220. For example, if a message is sent to three people, it immediately exists in four folders on the message server 105—the three Inbox folders of the recipients, and the Sent Items folder of the sender. However, the indexer 220 recognizes that the four messages are identical, and saves only a single copy in the message table 422. A hash function is used to compare hash values of individual messages to determine uniqueness. Each message (e.g., message 424) is stored in association with a message ID (e.g., message ID 426).

The message archive 228 also includes one or more mailbox tables (e.g., mailbox 410) that each correspond to a mailbox on the messaging server 105. If a mailbox is removed from the message server 105, its corresponding mailbox table can be retained in the message archive 228 so its archived messages can be searched. The mailbox table 410 may be indexed on display name, date removed and server ID.

A mailbox table includes one or more mailbox folders (e.g., inbox folder 412, sent items folder 414) for each folder in the corresponding mailbox on the messaging server 105. The mailbox folder may be indexed on folder name and mailbox ID.

Each mailbox folder includes a mailbox message table 416 with a record for each message within the corresponding mailbox folder. Each record includes a pointer to a corresponding message in the messages table 422. For example, the inbox table 412 includes a mailbox message record 416 with a pointer to the message 424 having message ID 426.

Several other tables may also be included in the message archive 228. For instance, the messages table 422 may further include several tables in which to store additional information, such as a recipients table, an Internet headers table, and the like. Message attachments may also be stored in an attachments table and associated with their corresponding message(s). These and other alternatives will become apparent to those skilled in the art of knowledge discovery.

The structure and nature of the message archive 228, in combination with the index store 230 (FIG. 2), enables certain functionality not possible with existing technologies. For instance, by permanently archiving every message in the message table 422, and by permanently archiving the mailbox and folder structures for each user (e.g., mailbox 410), there will exist a discoverable delivery history for each message. For example, consider the situation where a particular message (e.g., a message that violates some corporate policy) is received by a first user, forwarded to second and third users, and finally forwarded from the third user to some recipient outside the company. Regardless of whether those users deleted all evidence of the malicious message from the mailboxes over which they have control (e.g., the storage facilities of the message server 105), the message archive 228 will persist the message in the message table 422, and pointers to that message will exist in the archived mailbox table structures (e.g., mailbox 410) for each of the users that received the message. Accordingly, the path of that message can be easily traced using the search facilities enabled by the message archive server 110. In other words, by identifying which mailboxes (e.g., mailbox 410) the malicious message has been in, an administrator or other authorized party can easily “follow the trail” of a message from its first arrival at the enterprise message server 105 to every subsequent recipient inside the company, and even identify a recipient outside the company to whom the message may have been forwarded. This feature can have many advantages in the area of forensic discovery.

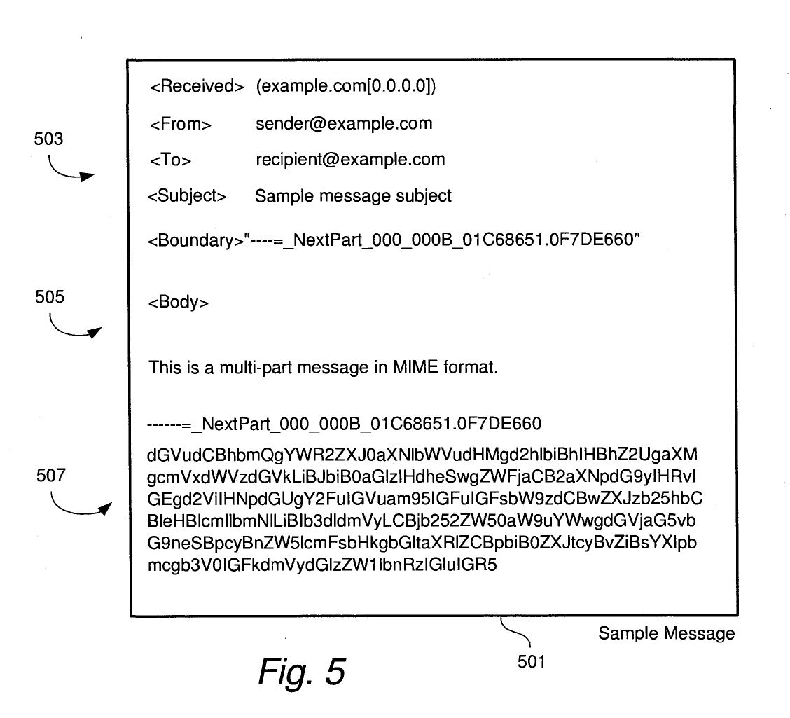

FIG. 5 is a conceptual illustration of a sample message 501 of the type that may be archived and retrieved. In this example, the sample message 501 is an e-mail message, although in alternative embodiments other types of messages may be archived, such as IM messages, VOIP, or the like.

In this illustration, the sample message 501 includes several headers 503, such as a From header and a Subject header. The message also includes a body 505, which may contain any form of alphanumeric characters. In certain embodiments, the message 501 may be configured as a multipart message and include additional information 507, such as attachments or other binary content.

The message 501 may be broken down into several “words”, where each word may be characterized as a set of alphanumeric characters. The message 501 may contain a number of words, although all the words may not be unique within the message 501.

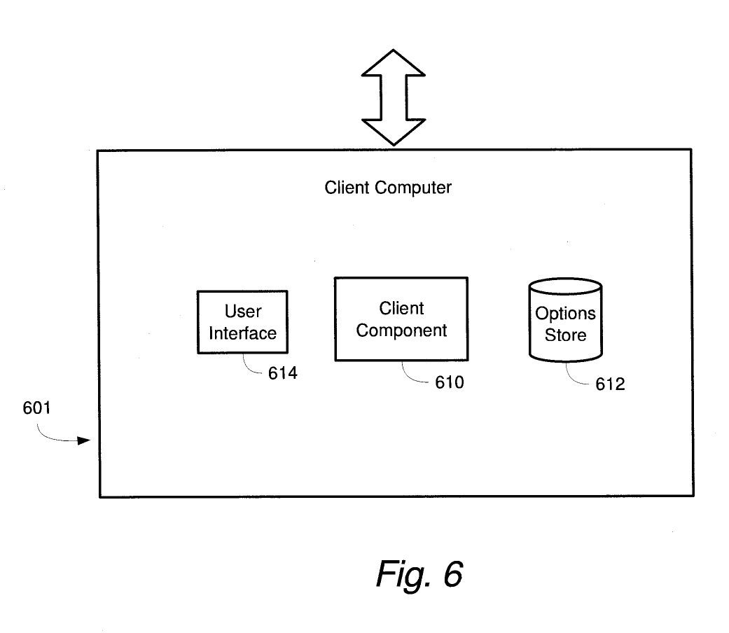

FIG. 6 is a functional block diagram generally illustrating a client computer 601, which may be any computing device coupled to the message archive server 110. A client component 610 is installed on the client computer 601. the client component 610 is the “viewer” for the archived messages, allowing authorized users access to the data maintained by the message archive server 110. For example, the client component 610 enables a user to view statistics that have been gathered, and to create and run custom searches on the message archive 228, searching for word matches and other criteria such as message size and date received. Other components may also be included in the client computer 601, such as an options store 612 for storing user preferences and a user interface 614 for generating a display.

The operation of this embodiment will now be demonstrated through illustrative processes for indexing messages and for searching indexed messages. The processes described here are presented as examples only, and should not be viewed as exclusive of other, alternative embodiments. Moreover, no particular significance should be attached to the order in which the steps of these processes are presented here. Rather, these steps may be performed in any order which the circumstances of the particular implementation warrant.

FIG. 7 is an operational flow diagram generally illustrating steps performed by a process for indexing character strings in messages, in accordance with one embodiment. In one embodiment, the process may be implemented by the system and components described above. However, in alternative embodiments, the process may also be implemented by entirely different components and systems.

To begin, as each incoming and outgoing message arrives at the Indexer, it is matched (701) to other messages in the message archive 228 to determine (step 703) if the same message has already been stored in the message archive 228. If there is already a copy of the message, no indexing is done on the new copy. Instead, pointers are added (step 705) to the appropriate tables indicating that the message is in multiple mailbox folders and mailboxes, but the full-text (word) index contains pointers to only a single copy of the message.

Each of the words in a new message are parsed (step 707) into an array of individual words and numbers. In this implementation, every word or character string is parsed and identified, including any meta data, headers, or the like associated with the message and/or any attachments. This process may be done in memory rather than on disk to improve speed. Special characters and spaces are ignored in the parsing process. In this embodiment, a ‘word’ means one or more contiguous characters and/or numeric digits.

For example, consider this brief message:
Hi Bob,
Did you say you needed a Java Developer? I know a guy who has been developing web sites in Java for three years. Let me know if you're interested.
Dave

The indexer 220 examines this message and may perform any one or more of the following actions:
The upper case characters are converted to lower case before indexing.
The punctuation (comma, question mark, period and apostrophe) are removed.
The word “you” appears three times in the message, the word “a” appears twice, and the word Java appears twice. The duplicates are ignored, but a count of the number of occurrences of each word is retained.
Several of the words in the message are in a NoiseWords table. Noise words are very common words that will not be indexed because they could make the indexes prohibitively large and slow, without significantly contributing to word search matches. The noise words in this message are: ‘hi’, ‘did’, ‘you’, ‘say’, ‘a’, ‘I’, ‘who’, ‘has’, ‘been’, ‘in’, ‘for’, ‘let’, ‘me’, ‘re’ and ‘if’. Most or all of these words can be ignored.

The remaining words are:

| Word | Count |
|---|---|
| bob | 1 |
| needed | 1 |
| java | 2 |
| developer | 1 |
| guy | 1 |
| developing | 1 |
| web | 1 |
| sites | 1 |
| three | 1 |
| years | 1 |
| know | 1 |
| interested | 1 |
| dave | 1 |

These words are added (step 709) to the dictionary table 311 if they are not already there. A “Use Count” field on the dictionary table 311 is incremented (step 711) by the numbers in the Count column above. This provides a total usage count for every word in the dictionary table 311. The total usage count may be used during searches to identify uncommon and rare words, which can be given a greater weight when identifying matching messages. It may also be used to identify immediately if a specific word exists anywhere in the archive when search criteria are entered.

As new words are added to the Dictionary table, their “stem” value is determined (step 713), using a programming procedure called the Porter Stemmer Algorithm. This algorithm is widely used on web sites and in other search software as a means of stripping suffixes from words in order to identify words that are similar (for example: friend, friends, friendly, friendliest, etc.) Using this stem value for indexing instead of the original word produces two benefits. First, it allows similar words or phrases to be found during the search. If the user searches for the phrase ‘Java developer’, it will find messages that contain the phrase ‘Java development’ or ‘developed in Java’. The second benefit of stems is that they reduce the size of the word index by reducing the total number of words that need to be indexed; e.g., if a message uses the word ‘developer’, ‘developing’ and ‘development’ in its body, only one word index entry is generated, on the stem word ‘develop’. By way of example, the stems for the words above include:

| Word | Stem |
|---|---|
| bob | bob |
| needed | need |
| java | java |
| developer | develop |
| guy | guy |
| developing | develop |
| web | web |
| sites | site |
| three | three |
| years | year |
| know | know |
| interested | interest |
| dave | dave |

Duplicate stems can be combined, and a count of the number of occurrences of each stem is calculated. Note that the words ‘developer’ and ‘developing’ both have the stem ‘develop’, so those two words are treated as two occurrences of one word. Any new stems that are not already in the Stems table are now added, and a cumulative counter is updated, indicating the number of times the stem is used in the entire database.

Finally, the word index 313 is updated (step 715) for this message. In this particular implementation, the word index 313 is a pointer table containing two four-byte integer values. The first integer value is the MessageID, a unique number assigned to each message in the Messages table. The second integer value is the StemID, a unique number assigned to each stem in the stems table. There is one additional one-byte field on the index that indicates the number of times the stem appeared in the message, so the record is nine bytes in length. In this implementation, regardless of the number of letters in a word, only nine bytes are required to index it. Accordingly, the word index is typically a large table containing millions of nine-byte records.

There were 32 words in the sample message above, and these have been reduced to 12 relevant stems, then stored in 12 nine-byte records. In addition, although the message appeared in both Bob's Sent Items folder and Dave's Inbox, it was indexed only once.

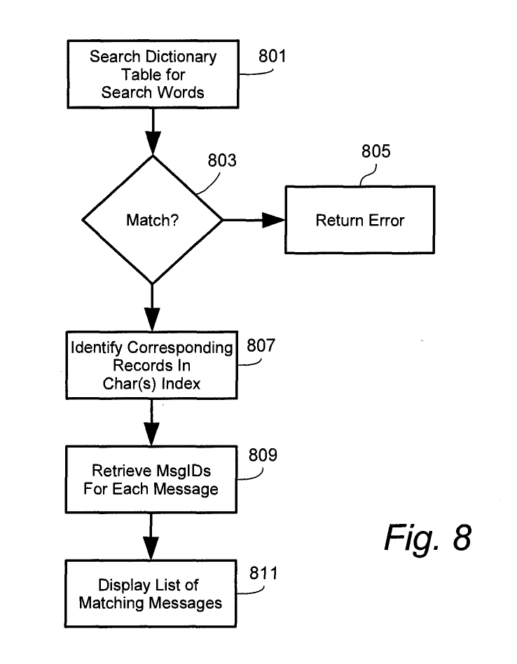

FIG. 8 is an operational flow diagram generally illustrating steps performed by a process for searching for messages in a message archive, in accordance with one embodiment. In one embodiment, the process may be implemented by the system and components described above. However, in alternative embodiments, the process may also be implemented by entirely different components and systems.

In this implementation, searches are structured using menu-driven Boolean search operators (and, or, not) that can be expanded or narrowed based on desired search criteria. For example, searches may be conducted on particular fields or portions of a message, such as a Sender, Recipient, E-mail Text, and Attachments portion. And because every word segment is indexed for all data-types (inboxes, file folders, public folders, and attachments), it is easy to perform global searches to retrieve data desired by the organization.

To begin, if searching for a phrase like ‘Java developer’ the client component 610 looks for (step 801) the search word in the dictionary table 311. If the search word is not found (step 803), an error may be returned (step 805). If the search word is found, the records in the word index 313 associated with the search word and its stem(s) are identified (step 807). In one implementation, an SQL “InnerJoin” is performed on those records. From those identified records, the message IDs for each message that includes the search word or its stem(s) can be easily retrieved (step 809). The result is a list of all the message IDs that are relevant to the current search.

Because of the nature and structure of this implementation, the ‘joining’ process is usually very fast, typically taking just a second or two to find the complete list of messages. This speed benefit differs significantly from existing technologies that perform searches by opening each stored message itself, which is a very slow and resource intensive process.

If other selection criteria have been included in the search, such as date ranges, specific mailboxes, message size and so forth, the SQL InnerJoin contains these comparisons as well, reducing the number of matches even further, with a single query.

The located messages may be displayed (step 811), perhaps with a ‘relevance score’ identifying messages that are probably more relevant than others. In one enhancement, the user can sort the matching messages by their relevance score to identify the most relevant messages. This scoring process uses the UseCount value described earlier, multiplied by a ‘rarity’ value for each word in the search phrase. The rarity value is higher for words that are rarely used in the company's email, causing the total relevance score to be higher if a rare word appears more than once in the document.

Rare and uncommon words may be determined using the total use count from the Dictionary table, described earlier. For example, a word that appears ten million times in the company's message archive would be considered a common word and would have a rarity value of 1, while a more unusual word that appears only a dozen times in the entire database might have a rarity value as high as 50. If the rare word appeared three times in the same message, its score would be 50×3, or 150.

In the search example described earlier, the resulting SQLjoin identifies all the messages that contain both the word ‘Java’ and the word ‘developer’, but the two words may not be in proximity to one another in the actual message. For example, the message might contain the phrase ‘Java tester’ in one paragraph and the phrase ‘VB developer’ in another paragraph. A message like that may not qualify as a match if the search has indicated that the words must be “near” one another. Accordingly, the client 610 may read the text of each of these ‘possible matches’ and scan them for the word ‘Java’ near the word ‘developer’ before it displays the message in the results grid.

As this secondary matching process takes place, messages with exact matches or ‘near’ matches start displaying in the Results grid as they are encountered. Messages that are not true matches are ignored, and the ‘possible matches’ value is reduced by 1. Two rolling counters on the ‘Search In Progress’ form indicate the number of ‘Possible Matches’ (from the SQL Join) and the number of ‘Matches’ (from the final process).

A search that returns just a few matches will perform the processes listed above in two or three seconds. A search that returns a few thousand matches will identify the ‘possible matches’ in a matter of seconds, and then immediately start displaying matches as it finds them, but it may take up to a minute or so to display every matching message in the View Results grid. During this time the user can start scrolling through the results grid and can click and view detail. The user can also click the ‘Cancel Search’ button at any time during the search to interrupt the process.

Many enhancements may be included in alternative embodiments of the invention. For example, alternative indexing techniques could be offered for different intended purposes—one for customers with limited database resources or who have limited disk storage, and another indexing technique for users who can handle larger database sizes.

A larger database would allow an index to be created that finds results faster, but would require more disk space. The index would be about five times larger than the design described above, but would eliminate the two-step process described. Every stem/word in a message would be indexed instead of every unique stem. That would require an additional field on each index record indicating the ‘position’ or ‘word number’ of each word in the document. This additional ‘position’ field would allow determining not only if two words are in a message, but if they are ‘near’ one another. The one-byte use count value in the word index would no longer be necessary.

This alternative technique would more closely approximate the indexing methods used by large Internet search engines, allowing the Client to display matching messages immediately, with the most relevant messages displayed first.

Another possible improvement is a custom extension to the Porter Stemmer Algorithm. As mentioned earlier, this algorithm is widely used on web sites and in other search software as a means of stripping suffixes from words in order to identify words that are similar (friend, friends, friendly, friendliest, etc.) Originally designed in 1980 by Martin Porter, the algorithm has been translated into many programming languages. However, even the author of the algorithm admits that its results are sometimes less than perfect.

As new buzzwords and jargon are added to the English language, improvements sometimes need to be made to search engines. For example, searching for the letters ‘.Net’ (as in Microsoft .Net Architecture, sometimes referred to as ‘dot-Net’) will return the word ‘net’, since punctuation is dropped. This can cause a large number of mismatches if someone is searching specifically for messages relating to dot-Net technology but is given all messages containing the word ‘net’.

Likewise, the abbreviation IT is often used in companies to identify the Information Technology department. This acronym may be mis-recognized as the word ‘it’, which is considered a noise word, and may not be indexed at all. Instead, the indexer could be configured to recognize the use of upper-case IT (not surrounded by other upper-case words) and allow it to be indexed.

Similarly, ‘pseudo-stems’ can be created to increase the odds of finding an abbreviated or misspelled version of a word when searching. For example, ‘Visual Basic’ is often abbreviated ‘VB’. The web site Dice.Com, which contains job descriptions for technical people, recognizes that these two phrases are the same, and treats them as if they are the same words when searching; i.e., a search for VB will return matches for both ‘VB’ and ‘Visual Basic’. Likewise, with a bit of programming, a search for ‘$300’ could return the phrase ‘three hundred dollars’, or a search for December 1997 could return Dec '97.

These customizations to the Porter Stemmer Algorithm can be incorporated into a CustomStems table and initially set up with a set of standard stem improvements that most customers would want to have. Because it is in a table, it can also be customized by customers to meet their specific needs. For example, the Engines Division of Honeywell employs thousands of engineers, but the Porter stem for ‘engineer’ and ‘engine’ are the same. Searching for ‘mechanical engineer’ using stems will also return messages about an engine mechanic. With a simple addition to the CustomStems table, the discrepancy can be resolved. In this case, the customization is actually disabling a stem in the Porter Stemmer rather than adding a new stem.

In still another enhancement, the message archive server 110 can be configured to filter certain messages for security purposes. For example, in one alternative implementation, the message archive server 110 could be configured with filters so that as any new message arrives at the message server 105, that event is noticed by the control engine 224. The indexer 220 could be configured with filters to identify certain messages that warrant heightened scrutiny or security. For example, any message directed to the CEO of an entity may be tagged for heightened security. Accordingly, if the indexer 220 identifies any such tagged messages, it may instruct the control engine 224 to immediately cause the message server 105 to delete any reference to that message in the message server's data stores. In this way, sensitive messages can be stored at the message archive 228 but not at the message server 105, thus preventing persons with access to the message server 105 (e.g., systems or IT personnel) from having access to those sensitive messages. In yet another enhancement to this implementation, a special utility or service could be incorporated into the message server 105 to redirect the tagged messages directly to the message archive server 110 without ever being received at the message server 105.

It should be noted that reference to e-mail messages throughout this document does not exclude other embodiments of the invention. Rather, it is envisioned that embodiments of the invention will be implemented to archive electronic documents in any form. For example, another embodiment could be implemented that archives instant messages or VOIP. In another example, an alternative embodiment could be implemented to archive electronic documents stored on an enterprise file server.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the art of knowledge retrieval may recognize, however, that embodiments may be practiced without one or more of the specific details, or with other methods, resources, materials, etc. In other instances, well known structures, resources, or operations have not been shown or described in detail merely to avoid obscuring aspects of the embodiments.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

1. A computer-readable medium encoded with computer-executable instructions for archiving messages, the instructions comprising:
receiving notice from a messaging server that a new message has arrived at the messaging server;
retrieving a copy of the new message from the messaging server;
parsing the new message to identify a plurality of words in the new message;
storing the copy of the new message in a message archive; and
including in a data store a unique record for each word in the plurality of words, the unique record being associated with a corresponding word, the unique record including a word count and a message pointer, the word count identifying a number of times the corresponding word appears in the new message, the message pointer identifying the new message in the message archive.

2. A computer-readable medium encoded with computer-executable instructions for indexing messages, the instructions comprising:
parsing a document to identify a list of character strings;
identifying new character strings from the plurality of character strings by comparing each character string in the list of character strings to a dictionary table of known character strings, the new character strings being any character strings in the list of character strings that do not appear in the dictionary table;
adding an entry in the dictionary table for each new character string;
counting a number of times that each new character string appears in the document; and
creating an index record for each new character string, each index record being associated with a particular new character string, each index record further including the count of the number of times the new character string appears in the corresponding document.

3. A computer-readable medium encoded with computer-readable instructions for identifying messages in a data store, the instructions comprising:
receiving a request for a search, the request identifying at least one search string;
searching a dictionary table for an entry that matches the search string, the dictionary table including entries for a plurality of known strings, each known string appearing in at least one message in the data store;
identifying at least one index record associated with the matching entry, each index record including a pointer to a corresponding message in the data store, the index record further including a count of a number of times the search string appears in the corresponding message; and
retrieving the corresponding message from the data store.

4. The computer-readable medium recited in claim 3, wherein a plurality of index records are associated with the matching entry, and further wherein each index record in the plurality of index records identifies a transient location at which the corresponding message resided at least briefly.

5. The computer-readable medium recited in claim 4, wherein each transient location comprises a mailbox associated with a message server, and wherein displaying the plurality of index records reveals a path that the corresponding message traversed among the mailboxes in the message server.
